(19) United States
(12) Patent Application Publication
(10) Pub. No.: US 2017/0210091 A1
(43) Pub. Date: Jul. 27, 2017

(54) CONSTRUCTION BOARDS HAVING A PRESSURE-SENSITIVE ADHESIVE LAYER

(71) Applicant: FIRESTONE BUILDING PRODUCTS CO., LLC, Indianapolis, IN (US)

(72) Inventors: William Robert McJUNKINS, Indianapolis, IN (US); Jiansheng Tang, Westfield, IN (US); Brian Scott Alexander, Westfield, IN (US); Carl Edward Watkins, JR., Carmel, IN (US); Timothy Dean Tackett, Indianapolis, IN (US)

(73) Assignee: FIRESTONE BUILDING PRODUCTS CO., LLC, Indianapolis, IN (US)

(21) Appl. No.: 15/326,856

(22) PCT Filed: Jul. 20, 2015
(86) PCT No.: PCT/US2015/041120

§ 371 Date: Jan. 17, 2017

Related U.S. Application Data
(60) Provisional application No. 62/026,198, filed on Jul. 18, 2014.

(51) Int. Cl. B32B 5/18; B32B 7/12; E04D 11/02; B32B 37/15; B32B 37/12; E04C 2/296; B32B 7/06; B32B 29/00

(52) U.S. Cl. CPC B32B 5/18; B32B 7/06; B32B 7/12; B32B 29/007; B32B 37/15; B32B 37/1207; E04C 2/296; E04D 11/02; B32B 2255/12; B32B 2255/26; B32B 2262/062; B32B 2262/101; B32B 2266/0278; B32B 2266/0285; B32B 2266/08; B32B 2307/304; B32B 2307/748; B32B 2419/06; B32B 2037/1215

(57) ABSTRACT

A construction board comprising a foam layer, an pressure-sensitive adhesive layer that is at least partially cured, and a release liner.

This application claims the benefit of U.S. Provisional Application Serial No. 62/026,198 filed on Jul. 18, 2014 which is incorporated herein by reference.

### FIELD OF THE INVENTION

Embodiments of the present invention are directed toward construction boards having a pressure-sensitive adhesive layer that is at least partially cured.

### BACKGROUND OF THE INVENTION

Construction boards, particularly those employed in the construction industry, may include a foam layer and at least one facer. Often, the foam layer is sandwiched between two facers. The foam layer can include a closed cell polyurethane, closed cell polyurea, closed cell phenolic foam, or polyisocyanurate foam. Examples of construction boards include polyisocyanurate or polyurethane foam construction boards used in the roofing industry, particularly those used to cover low-sloped or flap roofs. These boards may include insulation boards that are used primarily as a roof insulation, or cover boards, which are typically higher in density and are primarily used to protect the underlying substrate (e.g., underlying insulation boards).

Construction boards, especially those used to cover a roof surface, are often applied by using mechanical fasteners. These fasteners typically include a plate that extends the surface area that is contacted between the fastener and the board. The fastener is an element that protrudes through the plate and can pierce the board and penetrate the underlying roof deck (e.g., a wood deck). Multiple fasteners and plates are employed for each board in predetermined patterns to counteract strong wind uplift forces that are often encountered on the roof.

While mechanical fasteners are commonly used and accepted by the industry, they have several drawbacks. First, installation using mechanical fasteners is labor intensive, especially in view of the number of fasteners and plates used for each board. This increases both installation time and costs. Also, the fasteners can act as “thermal bridges” and thereby transfer heat between the upper surface of the roof construction and the underlying roof deck (or even the interior of the structure).

In the alternative, construction boards have been applied to a roof surface using adhesives. For example, hot asphalt or polyurethane foam adhesives have been employed to secure insulation board by applying a layer of adhesive (e.g., a two-part polyurethane adhesive), and then subsequently positioning the insulation boards over the adhesive layer. While this technique may be less labor intensive and provides adhesion over the entire surface of the board (i.e., it creates a fully-adhered system), drawbacks nonetheless exist. First, hot asphalt requires specialized training and equipment to install safely. Polyurethane foam adhesives are difficult to handle and can require trained applicators to apply. Also, these adhesives may contain volatile organics that are released into the environment during installation.

Those familiar with the industry are also aware of many products that carry pressure-sensitive adhesives to facilitate installation. Typically, these pressure-sensitive adhesives are applied to construction articles as hot-melt pressure sensitive adhesives. While applying the adhesives as a hot-melt offers a number of advantages, including the lack of volatile organic compounds, the fact that these adhesives have a workable melt temperature also indicates that the adhesives have a maximum operating temperature. That is, where the temperature on the roof nears the glass transition temperature of the adhesive, the adhesive strength offered by the pressure-sensitive adhesive is not maintained. Therefore, there are maximum temperature limits that the adhesive can withstand while maintaining integrity, especially with respect to wind uplift forces. Thus, the use of pressure-sensitive adhesives to secure insulation boards to a roof deck has not gained wide acceptance in the industry.

### SUMMARY OF THE INVENTION

Embodiments of the present invention provide a construction board comprising a foam layer, a pressure-sensitive adhesive layer that is at least partially cured, and a release liner.

Still other embodiments of the present invention provide a method for forming a construction board having an at least partially cured, pressure-sensitive adhesive, the method comprising extruding a curable hot-melt adhesive onto a facer disposed on a polyurethane or polyisocyanurate foam to form an adhesive layer, at least partially curing said adhesive using UV radiation, and applying a release film to said adhesive layer.

Still other embodiments of the present invention provide a roof system comprising a roof deck, an insulation board or cover board over said roof deck, and a membrane over said insulation board or cover board, where said insulation board or cover board is fully secured to an underlying substrate through an at least partially-cured pressure-sensitive adhesive.

### BRIEF DESCRIPTION OF THE DRAWINGS

FIG. 1 is a perspective fragmentary view of a construction board according to one or more embodiments of the present invention.

FIG. 2 is a schematic of a continuous process for making construction board according to one or more embodiments of the present invention.

FIG. 2A is a cross sectional view of a composite employed in the process of FIG. 2.

FIG. 2B is a cross sectional view of a composite employed in the process of FIG. 2.

FIG. 3 is a fragmentary cross-sectional view of a construction board attached to a roof deck according to one or more embodiments of the present invention.

### DETAILED DESCRIPTION OF ILLUSTRATIVE EMBODIMENTS

Embodiments of the present invention are based, at least in part, on the discovery of a construction board carrying a layer of at least partially cured pressure-sensitive adhesive. These adhesives are advantageously applied to the construction board as a hot-melt adhesive and subsequently cured. It has advantageously been discovered that these construction boards, which can be used, for example, as insulation boards or cover boards on low-sloped or flat roofs, can be secured through the pressure-sensitive adhesive and withstand the requisite wind uplift forces at technologically useful high temperatures. Notably, the use of the at least partially cured pressure-sensitive adhesive unexpectedly provides technologically useful green strength (i.e. initial bond strength) and long-term bond strength despite the relatively narrow thickness of the adhesive layer.

### Construction Board Overview

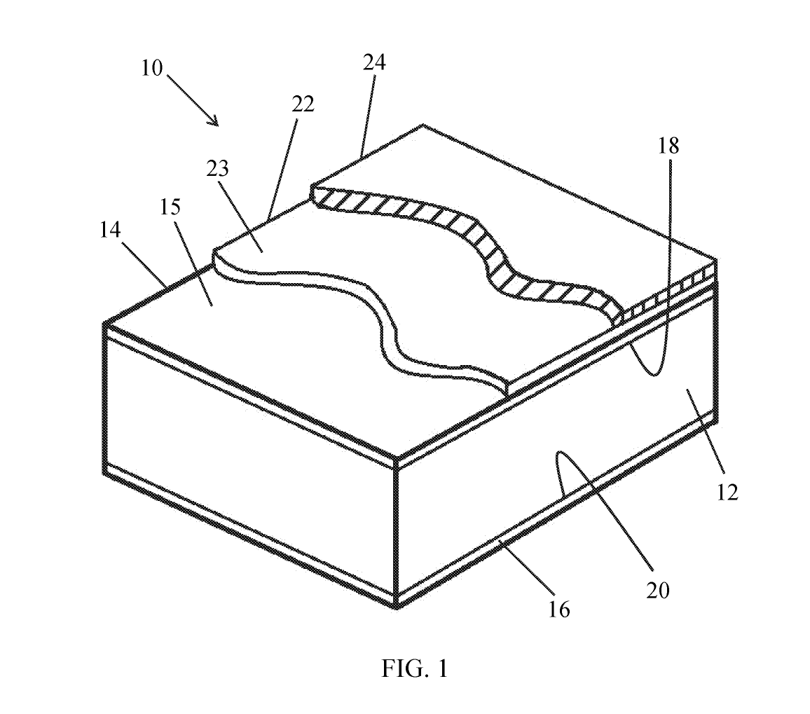

Construction boards of one or more embodiments of the present invention may be described with reference to FIG. 1. FIG. 1 shows a construction board that is indicated generally by the numeral 10. Construction board 10 includes a foam layer 12 sandwiched between first facer 14 and optional second facer 16. Facers 14 and 16 are attached to foam layer 12 at first planar surface 18 and second planar surface 20, respectively, of foam layer 12. In one or more embodiments, facer 14 (and optionally facer 16) is continuous over the entire planar surface 18 (or planar surface 20). Adhesive layer 22 is disposed on planar surface 15 of facer 14 and may be continuous over the entire surface of planar surface 15. Release member 24 is disposed on and removably attached to a planar surface 23 of adhesive layer 22.

In one or more embodiments, foam layer 12 includes a rigid closed-cell foam structure. In one or more embodiments, foam layer 12 may include a polyurethane, polyurea, phenolic, or polyisocyanurate foam.

In one or more embodiments, foam layer 12 may be characterized by a foam density (ASTM C303) that is less than 2.5 pounds per cubic foot (12 kg/m²), in other embodiments less than 2.0 pounds per cubic foot (9.8 kg/m²), in other embodiments less than 1.9 pounds per cubic foot (9.3 kg/m²), and still in other embodiments less than 1.8 pounds per cubic foot (8.8 kg/m²). In one or more embodiments, the foam layer 12 of insulation boards is characterized by having a density that is greater than 1.50 pounds per cubic foot (7.32 kg/m²), or in other embodiments, greater than 1.55 pounds per cubic foot (7.57 kg/m²).

Where the density of foam layer 12 is less than 2.5 pounds per cubic foot, it may be advantageous for foam layer 12 to be characterized by having an index of at least 120, in other embodiments at least 150, in other embodiments at least 175, in other embodiments at least 200, and in other embodiments at least 225, as determined by PIR/PUR ratio as determined by IR spectroscopy using standard foams of known index (note that ratio of 3 PIR/PUR provides an ISO Index of 300). Foam construction boards having a foam layer of similar nature are described in U.S. Pat. Nos. 6,117,375, 6,044,604, 5,891,563, 5,573,092, U.S. Publication Nos. 2004/01099832003/0082365, 2003/0153656, 2003/0032351, and 2002/0013379, as well as U.S. Ser. Nos. 10/640,895, 10/925,654, and 10/632,343, which are incorporated herein by reference.

In other embodiments, foam layer 12 may be characterized by density that is greater than 2.5 pounds per cubic foot (12.2 kg/m²), as determined according to ASTM C303, in other embodiments the density is greater than 2.8 pounds per cubic foot (13.7 kg/m²), in other embodiments greater than 3.0 pounds per cubic foot (14.6 kg/m²), and still in other embodiments greater than 3.5 pounds per cubic foot (17.1 kg/m²). In one or more embodiments, the density of foam layer 12 of the recovery boards may be less than 20 pounds per cubic foot (97.6 kg/m²), in other embodiments less than 10 pounds per cubic foot (48.8 kg/m²), in other embodiments less than 6 pounds per cubic foot (29.3 kg/m²), in other embodiments less than 5.9 pounds per cubic foot (28.8 kg/m²), in other embodiments less than 5.8 pounds per cubic foot (28.3 kg/m²), in other embodiments less than 5.7 pounds per cubic foot (27.8 kg/m²), in other embodiments less than 5.6 pounds per cubic foot (27.3 kg/m²), and still in other embodiments less than 5.5 pounds per cubic foot (26.9 kg/m²). Foam construction boards having a foam layer of similar nature are described in U.S. application Ser. Nos. 11/343,466 and 12/525,159, which are incorporated herein by reference.

Where the density of foam layer 12 is greater than 2.5 pounds per cubic foot, it may be advantageous for foam layer 12 to be characterized by an ISO Index, as determined by PIR/PUR ratio as determined by IR spectroscopy using standard foams of known index (note that ratio of 3 PIR/PUR provides an ISO Index of 300) of at least 180, in other embodiments at least 200, in other embodiments at least 220, in other embodiments at least 270, in other embodiments at least 285, in other embodiments at least 300, in other embodiments at least 315, and in other embodiments at least 325. In these or other embodiments, the ISO Index may be less than 360, in other embodiments less than 350, in other embodiments less than 340, and in other embodiments less than 335.

In one or more embodiments, facer 14 (and optionally optional facer 16) may include a variety of materials or compositions, many of which are known or conventional in the art. Useful facers include those comprising aluminum foil, cellulosic fibers, reinforced cellulosic fibers, craft paper, coated glass fiber mats, uncoated glass fiber mats, chopped glass, and combinations thereof. Useful facer materials are known as described in U.S. Pat. Nos. 6,774,071, 6,355,701, RE 36674, 6,044,604, and 5,891,563, which are incorporated herein by reference.

The thickness of the facer material may vary; for example, it may be from about 0.01 to about 1.00 inches thick (0.025-2.54 cm) or in other embodiments from about 0.015 to about 0.050 inches thick (0.04-0.13 cm), or in other embodiments from about 0.015 to about 0.030 inches thick (0.04-0.07 cm). The facer materials can also include more robust or rigid materials such as fiber board, perlite board, or gypsum board. The thickness of the rigid facer can vary; for example, the thickness of the rigid facer can be from about 0.2 to about 1.5 inches (0.51-3.8 cm), or in other embodiments from about 0.25 to about 1.0 inches (0.64-2.54 cm).

In one or more embodiments, facers 14 and 16 are optional. Therefore, in one or more embodiments, construction board 10 may be facerless. The ability to produce facerless construction boards is known as described in U.S. Pat. No. 6,117,375, which is incorporated herein by reference.

### Hot-Melt Curable Adhesives

In one or more embodiments, the curable hot-melt adhesive that may be used for forming the partially or fully cured pressure-sensitive adhesive layer may be from a family of polymers including acrylics two-component urethanes, two-component silane terminated polymers, block copolymers. In particular embodiments, the adhesive is a reactive hot-melt polyurethane adhesive, a hot melt pressure-sensitive polyamide adhesive, a two-component silane terminated polymer, a two-component urethane or an acrylic-based hot-melt adhesive. These adhesive compositions are commercially available in the art. For example, useful adhesives include those available under the tradename Tyforce H (DIC Corp.), Rapidex (HB Fuller), acResin (BASF), those available under the tradename AroCure (Ashland Chemical), and NovaMeltRC (NovaMelt). In one or more embodiments, these hot-melt adhesives may be cured (i.e., crosslinked) by moisture, Electron Beam, chemical reaction or UV light.

In one or more embodiments, the curable hot-melt adhesive that may be used for forming the cured pressure-sensitive adhesive layer may be an acrylic-based hot-melt adhesive. In one or more embodiments, the adhesive is a polyacrylate such as a polyacrylate elastomer. In one or more embodiments, useful polyacrylates include one or more units defined by the formula:

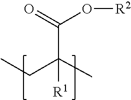

where each R¹ is individually hydrogen or a hydrocarbyl group and each R² is individually a hydrocarbyl group. In the case of a homopolymer, each R¹ and R², respectively, throughout the polymer are same in each unit. In the case of a copolymer, at least two different R¹ and/or two different R² are present in the polymer chain.

In one or more embodiments, hydrocarbyl groups include, for example, alkyl, cycloalkyl, substituted cycloalkyl, alkenyl, cycloalkenyl, substituted cycloalkenyl, aryl, substituted aryl, aralkyl, alkaryl, allyl, and alkynyl groups, with each group containing in the range of from 1 carbon atom, or the appropriate minimum number of carbon atoms to form the group, up to about 20 carbon atoms. These hydrocarbyl groups may contain heteroatoms including, but not limited to, nitrogen, oxygen, boron, silicon, sulfur, and phosphorus atoms. In particular embodiments, each R² is an alkyl group having at least 4 carbon atoms. In particular embodiments, R¹ is hydrogen and R² is selected from the group consisting of butyl, 2-ethylhexyl, and mixtures thereof.

In one or more embodiments, the polyacrylate elastomers that are useful as adhesives in the practice of this invention may be characterized by a glass transition temperature (Tg) of less than 0° C., in other embodiments less than −20° C., in other embodiments less than −30° C. In these or other embodiments, useful polyacrylates may be characterized by a Tg of from about −70 to about 0° C., in other embodiments from about −50 to about −10° C., and in other embodiments from about −40 to about −20° C.

In one or more embodiments, the polyacrylate elastomers that are useful as adhesives in the practice of this invention may be characterized by a number average molecular weight of from about 100 to about 350 kg/mole, in other embodiments from about 150 to about 270 kg/mole, and in other embodiments from about 180 to about 250 kg/mole.

In one or more embodiments, the polyacrylate elastomers that are useful as adhesives in the practice of this invention may be characterized by a Brookfield viscosity at 150° C. of from about 20,000 to about 70,000 cps, in other embodiments from about 30,000 to about 60,000 cps, and in other embodiments from about 40,000 to about 50,000 cps.

Specific examples of polyacrylate elastomers that are useful as adhesives in the practice of the present invention include poly(butylacrylate), and poly(2-ethylhexylacryalte). These polyacrylate elastomers may be formulated with photoinitiators, solvents, plasticizers, and resins such as natural and hydrocarbon resins. The skilled person can readily formulate a desirable coating composition. Useful coating compositions are disclosed, for example, in U.S. Pat. Nos 6,720,399, 6,753,079, 6,831,114, 6,881,442, and 6,887,917, which are incorporated herein by reference.

In other embodiments, the polyacrylate elastomers may include polymerized units that serve as photoinitiators. These units may derive from copolymerizable photoinitiators including acetophenone or benzophenone derivatives. These polyacrylate elastomers and the coating compositions formed therefrom are known as disclosed in U.S. Pat. Nos 7,304,119 and 7,358,319, which are incorporated herein by reference.

Useful adhesive compositions are commercially available in the art. For example, useful adhesives include those available under the tradename acResin (BASF), those available under the tradename AroCure (Ashland Chemical), and NovaMeltRC (NovaMelt). In one or more embodiments, these hot-melt adhesives may be cured (i.e., crosslinked) by UV light.

In one or more embodiments, the hot-melt adhesive is at least partially cured after being applied to the construction board, as will be discussed in greater detail below. In one or more embodiments, the adhesive is cured to an extent that it is not thermally processable in the form it was prior to cure. In these or other embodiments, the cured adhesive is characterized by physical crosslinks that form an infinite polymer network. While at least partially cured, the adhesive layer of one or more embodiments is essentially free of curative residue such as sulfur or sulfur crosslinks and/or phenolic compounds or phenolic-residue crosslinks.

In one or more embodiments, the pressure-sensitive adhesive layer may have a thickness of at least 51 μm (2 mil), in other embodiments at least 102 μm (4 mil), in other embodiments at least 127 μm (5 mil), and in other embodiments at least 152 μm (6 mil). In these or other embodiments, the pressure-sensitive adhesive layer has a thickness of at most 381 μm (15 mil), in other embodiments at most 305 μm (12 mil), and in other embodiments at most 254 μm (10 mil). In one or more embodiments, the adhesive layer has a thickness of from about 51 to about 381 μm (about 2 to about 15 mil), in other embodiments from about 102 to about 305 μm (about 4 to about 12 mil), and in other embodiments from about 127 to about 254 μm (about 5 to about 10 mil).

In one or more embodiments, the hot-melt adhesive composition is substantially devoid of tackifier or tackifier resin. As used herein, the term substantially devoid refers to that amount or less of tackifier resin that would otherwise have an appreciable impact on the adhesive compositions employed in the practice of the present invention. In one or more embodiments, the adhesive includes less than 2 weight percent, in other embodiments less than 1 weight percent, in other embodiments less than 0.5 weight percent, in other embodiments less than 0.1 weight percent, and in other embodiments less than 0.01 weight percent tackifier resin. In one or more embodiments, the adhesive composition is devoid of tackifier resin.

### Release Member

In one or more embodiments, release liner 24 (which may also be referred to as release member 24) includes a polymeric film or extrudate. This polymeric film or extrudate may include a single polymeric layer or may include two or more polymeric layers laminated or coextruded to one another. In other embodiments, release liner 24 includes a cellulosic substrate having a polymeric film or coating applied thereon, which film or coating may be referred to as a polymeric layer. The polymeric layer may be a single layer or include multiple layers.

Suitable materials for forming a release liner that is a polymeric film or extrudate include polypropylene, polyester, high-density polyethylene, medium-density polyethylene, low-density polyethylene, polystyrene or high-impact polystyrene. Suitable materials for forming a polymeric layer on a cellulosic-based release liner include siloxane-based materials, butadiene-based materials, organic materials (e.g. styrene-butadiene rubber latex), as well as those polymeric materials employed to form a film or extrudate as described above. These polymeric materials may offer a number of advantageous properties including high moisture resistance, good resistance to temperature fluctuations during processing and storage, and increased tear and wrinkle resistance. The above referenced films and materials may be coated with a release agent, (e.g. —silicone).

In one or more embodiments, the release member is characterized by a thickness of from about 15 to about 80, in other embodiments from about 18 to about 75, and in other embodiments from about 20 to about 50 μm.

### Process Overview

In one or more embodiments, the construction board of the present invention may be fabricated by first preparing a construction board by using conventional techniques. The boards of one or more embodiments of this invention can be manufactured by using known techniques such as known techniques for producing polyurethane or polyisocyanurate insulation. Generally the process includes mixing a first stream that includes an isocyanate-containing compound with a second stream that includes an isocyanate-reactive compound. Using conventional terminology, the first stream (i.e., the stream including an isocyanate-containing compound) may be referred to as an A-side stream, an A-side reactant stream, or simply an A stream. Likewise, the second stream (i.e., the stream including an isocyanate-reactive compound) may be referred to as a B-side stream, B-side reactant stream, or simply B stream.

The mixture of the A-side and the B-side stream is then deposited on to a facer that, within a continuous process, is continuously conveyed below the mix head in which the A-side and B-side streams are mixed. After the mixture is deposited on to the first facer, a second facer material is then applied over the mixture, which is in the form of a rising or expanding foam at this point. In other words, the mixture is sandwiched between two facer materials that are being continuously conveyed. This sandwiched structure is then typically conveyed into a laminator where the polyurethane/polyisocyanurate reaction is accelerated through the application of heat. Processes for the manufacture of polyurethane or polyisocyanurate insulation boards are known in the art as described in U.S. Pat. Nos. 6,117,375, 6,044,604, 5,891,563, 5,573,092, U.S. Publication Nos. 2004/0109983, 2003/0082365, 2003/0153656, 2003/0032351, and 2002/0013379, as well as U.S. Ser. Nos. 10/640,895, 10/925,654, and 10/632,343, which are incorporated herein by reference.

Once the construction board is constructed—at least partially—the next step of the process includes applying a layer of the hot-melt pressure-sensitive adhesive material to a surface of one of the facers of the board. As will be appreciated by those skilled in the art, this step may take place prior to final cutting or fabrication of the board (e.g., prior to trimming). In one or more embodiments, the hot-melt pressure-sensitive adhesive material is continuously applied to a surface of the facer as the partially constructed construction board exits the laminator. The hot-melt adhesive can be extruded on to the facer by using known apparatus such an adhesive coater. The adhesive can then be subsequently cured by using, for example, UV-radiation. A release film can then be applied to the adhesive layer, and then final cutting and finishing of the construction board can take place. For example, the continuous structure can be cut to length, trimmed, and ultimately stacked for storage and/or shipment.

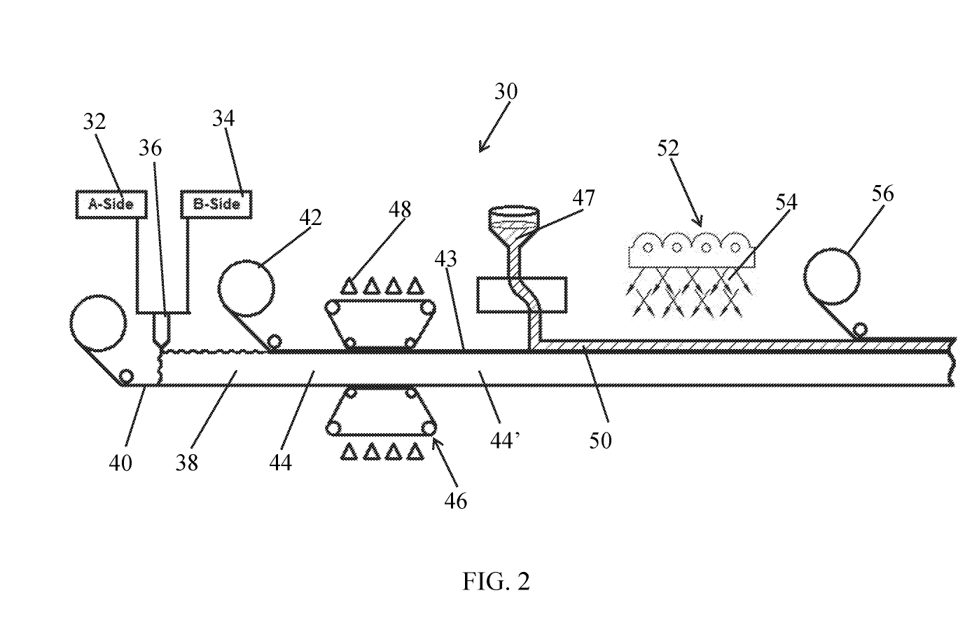

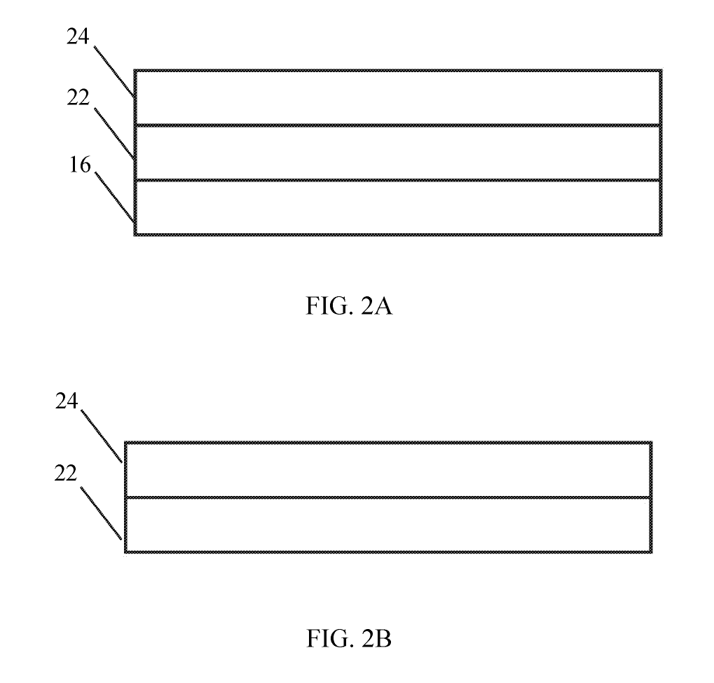

As generally shown in FIG. 2, process 30 for preparing a construction board according to the present invention includes the step of mixing an A-side stream 32 with a B-side stream 34 at one or more mix heads 36 and depositing the mixture 38, which may also be referred to as a rising foam 38, on to a first facer 40. A second facer 42 is then applied to rising foam 38 to form a continuous sandwiched structure 44. This sandwiched structure 44 is then directed into a laminator 46 where heat 48 may be applied to further drive the polyurethane/polyisocyanurate reaction. Upon exiting laminator 46, the at least partially cured sandwiched structure 44′ is then directed toward a coating step wherein hot-melt pressure-sensitive adhesive 48 is extruded on to the top surface 43 of facer 42 to form adhesive layer 50. The at least partially cured sandwiched structure 44′ now carrying adhesive layer 50 is then directed toward a UV-curing station 52 where sufficient UV energy is applied to the coating to thereby effect a desirable curing or crosslinking of the adhesive. In one or more embodiments, this can be effected by using microwave-type UV lamps, fluorescent-type UV lamps, mercury-type UV lamps or LED UV lamps. As the skilled person appreciates, the desired dosage of UV energy can be supplied to adhesive layer 50 by adjusting the UV intensity and exposure time. The intensity can be manipulated by the power supplied to the respective lamps and the height (H) that the lamps are placed above the surface of coating 50. Exposure time can be manipulated based upon the line speed (i.e., the speed at which sandwiched structure 44 carrying coating layer 50 is passed through a UV curing step).

Once the adhesive has been sufficiently cured by exposure to UV radiation 54, a release liner 56 can be applied to the cured coating in a subsequent step. Following application of liner 56, the construction board can be further fabricated such as, for example, by cutting, trimming, and ultimately stacking for storage and/or shipment.

In one or more embodiments, adhesive layer 50 applied to top surface 43 of facer 42 has a thickness of from about 3 mil to about 10 mil, in other embodiments from about 4 mil to about 9 mil, in other embodiments from about 5 mil to about 7 mil, and in other embodiments about 6 mil. In one or more embodiments, the coating has a uniform thickness such that the thickness of the coating at any given point on the surface of the membrane does not vary by more than 2 mil, in other embodiments by more than 1.5 mil, and in other embodiments by more than 1 mil.

In one or more embodiments, UV energy 54 may be applied to coating layer 50 at a UV dosage of from about 30 to about 100 millijoule/cm², in other embodiments from about 35 to about 90 millijoule/cm², in other embodiments from about 40 to about 80 millijoule/cm², in other embodiments from about 45 to about 75 millijoule/cm², and in other embodiments from about 48 to about 72 millijoule/cm².

In one or more embodiments, the energy supplied to the coating layer by UV lights 52 is in the form of UV-C electromagnetic radiation, which can be characterized by a wave length of from about 250 to about 260 nm. In one or more embodiments, the UV dosage applied during a UV curing step is regulated based upon a UV measuring and control system that operates in conjunction with a UV curing step. According to this system, UV measurements are taken proximate to the surface of the adhesive coating layer using known equipment such as a UV radiometer. The data from these measurements can be automatically inputted into a central processing system that can process the information relative to desired dosage and/or cure states and automatically send signal to various variable-control systems that can manipulate one or more process parameters. For example, the power supplied to the UV lamps and/or the height at which the UV lamps are positioned above the coating layer can be manipulated automatically based upon electronic signal from the central processing unit. In other words, the UV intensity, and therefore the UV dosage, can be adjusted in real time during the manufacturing process.

In one or more embodiments where the foam-forming material is deposited onto a coated facer, the foam-forming material can be deposited onto the side of the coated facer that does not include the coating. In other words, the foam-forming material is applied to the side of the facer that is opposite to the side of the facer where the coating was applied. In other embodiments where the foam-forming material is deposited onto a coated facer, the foam-forming material can be deposited onto a coated facer that includes a coating on both sides. In those embodiments where the foam-forming material is deposited onto an uncoated facer, a coating can later be applied to the facer (and to an optional additional facer).

In alternative embodiments, the hot-melt adhesive coating is pre-applied to one surface of the facer material prior to mating the facer with the foam or rising foam. For example, a coating layer of pressure-sensitive adhesive, as discussed above, can be applied to one planar surface of a facer, and then this coating can be subsequently cured using UV radiation as discussed above. Once sufficiently cured, a release liner can be removably mated to the exposed surface of the cured coating. The facer, which now carries the cured pressure-sensitive adhesive and release liner, can be employed in the manufacture of construction boards. Namely, the planar surface of the facer opposite the cured coating can be mated with the foam or rising foam (e.g., the rising foam can be deposited on to this planar surface of the facer).

For example, and with reference to FIG. 2, second facer 42 may, for example, include a composite that includes a first layer 42′ of facer material, a second layer 50′ of adhesive, and a third layer 56′ of release member, where release member 56′ and facer layer 42′ sandwich adhesive layer 50′, as shown in FIG. 2A. As suggested above, adhesive layer 50′ is pre-cured, thereby eliminating the application of adhesive, the UV curing, and application of release paper as discussed above with respect to FIG. 2 during manufacture of the foam. Instead, the adhesive can be applied to a facer material, the adhesive can be cured (again using curing techniques as described with reference to FIG. 2), and a release member can be applied to the cured adhesive, in a step that is separate and apart from the manufacture of the foam. Methods of applying and curing a UV-curable pressure-sensitive adhesive are disclosed in WO 2015/042258, which is incorporated herein by reference.

In yet other alternative embodiments, a composite that includes a first layer 50″ of adhesive and a release member 56″, as shown in FIG. 2B, can be employed in the process for manufacturing the foam as shown in FIG. 2. In other words, a release member carrying a cured pressure-sensitive adhesive can be applied to at least one of facers 40 and 42 either before or after forming the foam layer. Again, adhesive layer 50″ within this composite is pre-cured, thereby eliminating the application of adhesive and the subsequent curing of the adhesive as shown in FIG. 2. Instead, the adhesive can be applied to a release member and subsequently cured in a separate and distinct process from the manufacture of the foam.

### INDUSTRIAL APPLICABILITY

Practice of the present invention is not limited by the type of roof deck to which the construction boards of the present invention may be secured. For example, the roof decks may include conventional roof decks, such as those constructed of wood, steel, and/or concrete.

In one or more embodiments, the construction boards of the present invention can advantageously be applied to a roof deck or other substrate by using standard peel-and-stick techniques. That is, after removal of the release liner, the construction boards can then be adhered directly to the roof surface. In one or more embodiments, the construction boards can advantageously be adhered to the roof surface without the need for ballasting or other weight mechanisms that are typically employed to prevent wind uplift immediately following initial installation since the construction boards of the present invention advantageously have sufficient initial bond strength.

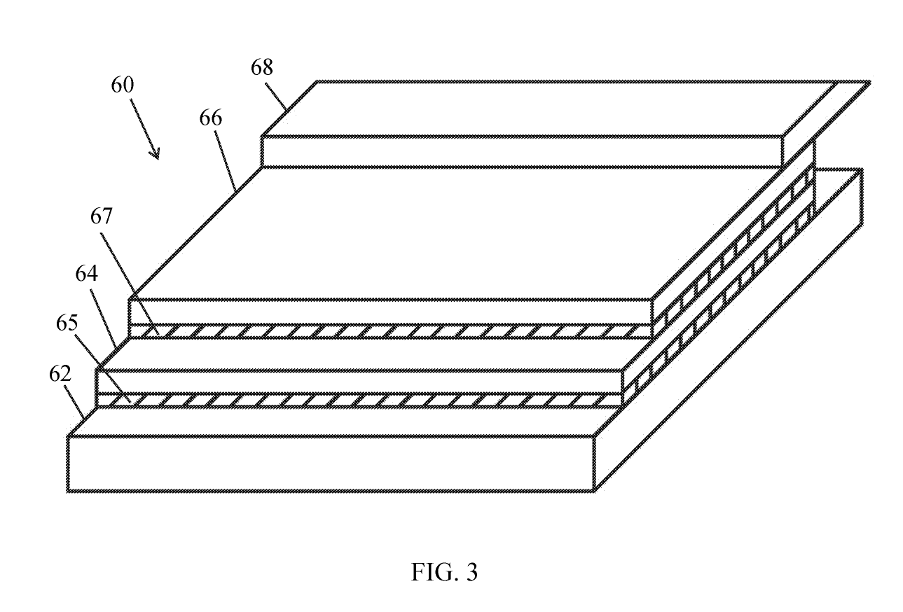

For example, as shown in FIG. 3, a roof system 60 can be constructed that includes roof deck 62, insulation board 64, cover board 66, and membrane 68. Insulation board 64 and cover board 66 may be constructed according to the present invention. That is, they may include at least partially cured pressure-sensitive adhesive layers 65 and 67, respectively. Insulation board 64 and cover board 66 may be installed by using peel-and-stick techniques whereby insulation board 64 can be secured to roof deck 62 by first removing a release liner and then securing insulation board 64 to roof deck 62 through pressure-sensitive adhesive layer 65. Similarly, cover board 66 can be applied to insulation board 64 through pressure-sensitive adhesive layer 67 after removal of a release liner. Membrane 68 can be applied over cover board 66 using conventional techniques.

Practice of the present invention is not necessarily limited by the selection of a particular roofing membrane. As is known in the art, numerous roofing membranes have been proposed in the art and several are used commercially including thermoset and thermoplastic roofing membranes. Commercially available thermoplastic roofing membranes may include polyvinyl chloride, or polyolefin copolymers. For example, thermoplastic olefin (TPO) membranes are available under the trade names UltraPly™, and ReflexEON™ (Firestone Building Products) and SureWeld™ (Carlisle SynTec). Commercially available thermoset roofing membranes may include elastomeric copolymers such as ethylene-propylene-diene copolymer (EPDM) rubber and functionalized olefins such as chlorosulfonated polyethylene (CSPE). For example, EPDM membranes are available under the trade name RubberGard™, RubberGard Platinum™, RubberGard EcoWhite™, and RubberGard MAX™ (Firestone Building Products). Useful EPDM membrane is disclosed in, for example, U.S. Pat. Nos 7,175,732, 6,502,360, 6,120,869, 5,849,133, 5,389,715, 4,810,565, 4,778,852, 4,732,925, and 4,657,958, which are incorporated herein by reference. EPDM membranes are commercially available from a number of sources; examples include those available under the tradenames RubberGard (Firestone Building Products) and SURE-SEAL (Carlisle SynTec).

As indicated above, practice of the present invention provides a fully-adhered system wherein the insulation boards and/or cover boards are fully adhered within the roofing system (e.g. they may be partially or fully adhered to the substrate). In one or more embodiments, these fully-adhered systems have improved resistance to wind uplift forces, and improved ease of application and installation. Also, 4′×8′ insulation boards can advantageously be installed without release of volatile organic compounds to the atmosphere. Moreover, the adhesion of the board to the underlying substrate is technologically advantageous. In one or more embodiments, the adhesion between the construction board and the underlying substrate may be characterized by a Factory Mutual 4450 wind uplift test or a Underwriters Laboratories UL580 wind uplift test, with values in excess of 90 pounds per square foot.

In one or more embodiments, the construction boards are insulation boards that meet the requirements of ASTM C1289. In other embodiments, the construction boards are cover boards that meet the specifications of ASTM C1289.

Various modifications and alterations that do not depart from the scope and spirit of this invention will become apparent to those skilled in the art. This invention is not to be duly limited to the illustrative embodiments set forth herein.

1. A construction board comprising:
a. a foam layer;
b. an pressure-sensitive adhesive layer that is at least partially cured; and
c. a release liner.

2. The construction board of the preceding claim, wherein said foam layer comprises a polyurethane, phenolic or polyisocyanurate cellular structure.

3. The construction board of claim 1, wherein said adhesive layer is an silane terminated hot melt pressure sensitive adhesive or acrylic-based hot-melt pressure sensitive adhesive.

4. The construction board of claim 1, wherein said adhesive layer includes a UV-cured acrylic pressure sensitive adhesive.

5. The construction board of any of claim 1, wherein said adhesive layer has a thickness of from about 51 to about 381 μm.

6. The construction board of claim 1, wherein said foam layer includes a density of less than 2.5 pounds per cubic foot and an ISO index of at least 120.

7. The construction board of claim 1, wherein said foam layer includes a density greater than 2.5 pounds per cubic foot and an ISO index of at least 270.

8. The construction board of claim 1, where the construction board includes a facer disposed on said foam layer, and said adhesive layer is disposed on said facer.

9. The construction board of claim 1, wherein the release liner is a polymeric film or a polymeric-coated paper.

10. The construction board of claim 1, where the adhesive layer has a Tg of less than 0° C.

11. A method for forming a construction board having an at least partially cured, pressure-sensitive adhesive, the method comprising:
a. extruding a curable hot-melt adhesive onto a facer;
b. at least partially curing said adhesive using UV radiation;
c. applying a release film to said adhesive layer; and
d. mating the facer to a foam or rising foam.

12. The method of claim 11, where the curable hot-melt adhesive is a silane-terminated hot-melt pressure-sensitive adhesive or an acrylic-based hot-melt pressure-sensitive adhesive.

13. The method of claim 11, where said step of extruding applies an adhesive layer having a thickness of from about 51 to about 381 μm.

14. The method of claim 11, where said foam has a density of less than 2.5 pounds per cubic foot and an ISO index of at least 120.

15. The method of claim 11, where the foam has a density that is greater than 2.5 pounds per cubic foot and an ISO index of at least 270.

16. The method of claim 11, where the adhesive has a Tg of less than 0° C.

17. A roof system comprising:
a. a roof deck;
b. an insulation board or cover board over said roof deck; and
c. a membrane over said insulation board or cover board, where said insulation board or cover board is fully secured to an underlying substrate through an at least partially-cured pressure-sensitive adhesive.
